(19) United States
(12) Patent Application Publication
(10) Pub. No.: US 2025/0150862 A1
(43) Pub. Date: May 8, 2025

(54) COMMUNICATION SYSTEM

(71) Applicant: NEC CORPORATION, Minato-ku, Tokyo (JP)

(72) Inventors: Zhe CHEN, Guildford (GB); Neeraj GUPTA, London (GB); Yuhua CHEN, London (GB)

(73) Assignee: NEC CORPORATION, Minato-ku, Tokyo (JP)

(21) Appl. No.: 18/838,331

(22) PCT Filed: Feb. 27, 2023
(86) PCT No.: PCT/JP2023/006920

§ 371 Date: Aug. 14, 2024

(30) Foreign Application Priority Data
Mar. 1, 2022 (GB) 2202786.6

(51) Int. Cl. H04W 24/04

(52) U.S. Cl. CPC H04W 24/04

(57) ABSTRACT

A communication system is disclosed which includes a distributed base station apparatus comprising a control plane unit, a user plane unit, and a distributed unit. Respective interfaces are set up between the control plane unit and the user plane unit, between the control plane unit and the distributed unit, and between the control plane unit and a core network node. The control plane unit acts as a master control plane unit. The user plane unit or the distributed unit obtains information identifying a further control plane unit to act as a redundant unit in case of a failure the master control plane unit. Corresponding interfaces are set up between the further control plane unit and the user plane unit, between the further control plane unit and the distributed unit, and between the further control plane unit and a core network node for resiliency.

### TECHNICAL FIELD

The present invention relates to a communication system.

### BACKGROUND ART

The invention has particular but not exclusive relevance to wireless communication systems and devices thereof operating according to the 3^{rd} Generation Partnership Project (3GPP) standards or equivalents or derivatives thereof. The invention has particular, although not necessarily exclusive relevance to resiliency of distributed apparatus such as a distributed base station in the so-called ‘5G’ (or ‘New Radio’) systems.

The latest developments of the 3GPP standards are referred to as ‘5G’ or ‘New Radio’ (NR). These terms refer to an evolving communication technology that supports a variety of applications and services. Various details of 5G networks are described in, for example, the ‘NGMN 5G White Paper’ V1.0 by the Next Generation Mobile Networks (NGMN) Alliance, which document is available from https://www.ngmn.org/5g-white-paper.html. 3GPP intends to support 5G by way of the so-called 3GPP Next Generation (NextGen) radio access network (RAN) and the 3GPP NextGen core network (NGC).

Under the 3GPP standards, the base station (e.g. an ‘eNB’ in 4G or a ‘gNB’ in 5G) is a node via which communication devices (user equipment or ‘UE’) connect to a core network and communicate to other communication devices or remote servers.

In the 5G architecture, the gNB internal structure may be split into at least two parts known as the Central Unit (CU) and the Distributed Unit (DU), connected by an F1 interface (or F1 application protocol, F1AP). In this ‘split’ architecture, typically ‘higher’, CU layers (for example, but not necessarily or exclusively), PDCP) and the typically ‘lower’, DU layers (for example, but not necessarily or exclusively, RLC/MAC/PHY) may be implemented separately. Thus, for example, the higher layer CU functionality for a number of gNBs may be implemented centrally (for example, by a single processing unit, or in a cloud-based or virtualised system), whilst retaining the lower layer DU functionality locally, in each of the gNB.

Specifically, a gNB (referred to herein as a ‘distributed’ gNB) may include the following functional units:
gNB Central Unit (gNB-CU): a logical node hosting Radio Resource Control (RRC), Service Data Adaptation Protocol (SDAP) and Packet Data Convergence Protocol (PDCP) layers of the gNB (or RRC and PDCP layers of an en-gNB) that controls the operation of one or more gNB-DUs. The gNB-CU terminates the F1 interface connected with the gNB-DU.
gNB Distributed Unit (gNB-DU): a logical node hosting Radio Link Control (RLC), Medium Access Control (MAC) and Physical (PHY) layers of the gNB or en-gNB, and its operation is partly controlled by gNB-CU. One gNB-DU supports one or multiple cells. One cell is supported by only one gNB-DU. The gNB-DU terminates the F1 interface connected with the gNB-CU.
gNB-CU-Control Plane (gNB-CU-CP): a logical node hosting the RRC and the control plane part of the PDCP protocol of the gNB-CU for an en-gNB or a gNB. The gNB-CU-CP terminates the so-called E1 interface (or E1 application protocol, E1AP) connected with the gNB-CU-UP and the F1-C(F1 control plane) interface connected with the gNB-DU. gNB-CU-User Plane (gNB-CU-UP): a logical node hosting the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U (F1 user plane) interface connected with the gNB-DU.

For simplicity, the present application will use the term base station to refer to any such base stations/gNBs, and use the term mobile device, user device, or UE to refer to any communication device that is able to connect to the core network via one or more base stations.

When using the above described distributed architecture, the split between gNB-CU and gNB-DU allows a highly-centralised gNB-CU deployment with large coverage area per gNB-CU, especially from the control plane (gNB-CU-CP) perspective. However, in this case, there is a risk that the centralised unit may become a single point of failure affecting many users. Accordingly, 3GPP considers the resiliency of the gNB-CU(-CP) to be of high importance and there are ongoing studies on possible resiliency enhancements, with the following objectives:
solutions for gNB-CU-CP failure recovery should minimise signalling towards the UEs and signalling load towards the network;
solutions for gNB-CU-CP failure recovery should minimise user plane interruptions, namely they should minimise the service downtime from the end-user perspective; and
solutions for minimisation of control plane interruptions should also be targeted.

### SUMMARY OF INVENTION

### Technical Problem

The inventors have identified a number of issues that need to be addressed in order to provide improved resiliency for the distributed base station. For example, even before the first UE is connected to the network via the distributed base station apparatus, the redundant interfaces (E1/F1/NG) of a secondary CU-CP should be established in advance. There is also a need to backup/migrate UE context from the main unit to the secondary unit in a timely and efficient manner to avoid having to re-configure all affected UE contexts upon failure of the main unit. Moreover, when one of the network entities detects breakdown of the main (master) CU-CP, it will activate the CU-CP resiliency. In this case, the secondary CU-CP will take over control of the UE(s), and the relative entities should be notified and apply the appropriate configuration to use the new (secondary) CU-CP. However, it is not yet known how such resiliency activation/notification and reconfiguration will be realised.

### Solution to Problem

Accordingly, preferred embodiments of the present invention aim to provide methods and apparatus which address or at least partially deal with one or more of the above issues whilst also meeting the above objectives.

Although for efficiency of understanding for those of skill in the art, the invention will be described in detail in the context of a 3GPP system (NR), the principles of the invention can be applied to other systems that employ similar distributed apparatus.

In one aspect, the invention provides a method performed by a control plane unit of a communication apparatus including at least the control plane unit, a user plane unit, and a distributed unit, the method comprising: transmitting, to at least one of the user plane unit and the distributed unit, information identifying a further control plane unit to act as a redundant unit for the control plane unit for at least one user equipment (UE) served by the control plane unit.

In one aspect, the invention provides a method performed by a communication apparatus including a control plane unit, a user plane unit, and a distributed unit, the method comprising receiving, from at least one of the control plane unit and an operations and maintenance node, information identifying a further control plane unit to act as a redundant unit for the control plane unit for at least one user equipment (UE) served by the control plane unit.

In one aspect, the invention provides a method performed by a communication apparatus including at least a control plane unit, a user plane unit, and a distributed unit, the method comprising: initiating a procedure for configuring a further control plane unit to act as a resilient node for the control plane unit by transmitting at least one signalling message to the further control plane unit; and backing up a UE context associated with a user equipment (UE) served by the control plane unit at the resilient node.

In one aspect, the invention provides a method performed by a communication apparatus including at least a control plane unit configured as a control plane unit, a user plane unit, and a distributed unit, coupled to a further control plane unit configured as a resilient node for the control plane unit, the method comprising: determining a failure of the control plane unit; and transmitting a message to the further control plane unit for initiating a procedure to activate the further control plane unit as the resilient node.

In one aspect, the invention provides a method performed by a control plane unit configured as a resilient node for a control plane unit of a communication apparatus including a user plane unit and a distributed unit, the method comprising: receiving, from the user plane unit or the distributed unit, a message for initiating a procedure to activate the resilient node, in case of a failure of the control plane unit of the communication apparatus; and communicating with at least one user equipment (UE), using the user plane unit or the distributed unit.

In one aspect, the invention provides a method performed by an operations and maintenance node, the method comprising: transmitting, to a node of a communication apparatus including a control plane unit, a user plane unit, and a distributed unit, information identifying a further control plane unit to act as a redundant unit for the control plane unit for at least one user equipment (UE) served by the control plane unit.

In one aspect, the invention provides a control plane unit for a communication apparatus including at least the control plane unit, a user plane unit, and a distributed unit, the control plane unit comprising means (for example a memory, a controller, and a transceiver) for transmitting, to at least one of the user plane unit and the distributed unit, information identifying a further control plane unit to act as a redundant unit for the control plane unit for at least one user equipment (UE) served by the control plane unit.

In one aspect, the invention provides a communication apparatus including a control plane unit, a user plane unit, and a distributed unit, the communication apparatus comprising means (for example a memory, a controller, and a transceiver) for receiving, from at least one of the control plane unit and an operations and maintenance node, information identifying a further control plane unit to act as a redundant unit for the control plane unit for at least one user equipment (UE) served by the control plane unit.

In one aspect, the invention provides a communication apparatus including at least a control plane unit, a user plane unit, and a distributed unit, the communication apparatus comprising: means (for example a memory, a controller, and a transceiver) for initiating a procedure for configuring a further control plane unit to act as a resilient node for the control plane unit by transmitting at least one signalling message to the further control plane unit; and means for backing up a UE context associated with a user equipment (UE) served by the control plane unit at the resilient node.

In one aspect, the invention provides a communication apparatus including at least a control plane unit configured as a control plane unit, a user plane unit, and a distributed unit, coupled to a further control plane unit configured as a resilient node for the control plane unit, the communication apparatus comprising: means (for example a memory, a controller, and a transceiver) for determining a failure of the control plane unit; and means for transmitting a message to the further control plane unit for initiating a procedure to activate the further control plane unit as the resilient node.

In one aspect, the invention provides a control plane unit for being configured as a resilient node for a control plane unit of a communication apparatus including a user plane unit and a distributed unit, the control plane unit comprising: means (for example a memory, a controller, and a transceiver) for receiving, from the user plane unit or the distributed unit, a message for initiating a procedure to activate the resilient node, in case of a failure of the control plane unit of the communication apparatus; and means for communicating with at least one user equipment (UE), using the user plane unit or the distributed unit.

In one aspect, the invention provides an operations and maintenance node comprising means (for example a memory, a controller, and a transceiver) for transmitting, to a node of a communication apparatus including a control plane unit, a user plane unit, and a distributed unit, information identifying a further control plane unit to act as a redundant unit for the control plane unit for at least one user equipment (UE) served by the control plane unit.

Aspects of the invention extend to corresponding systems and computer program products such as computer readable storage media having instructions stored thereon which are operable to program a programmable processor to carry out a method as described in the aspects and possibilities set out above or recited in the claims and/or to program a suitably adapted computer to provide the apparatus recited in any of the claims.

Each feature disclosed in this specification (which term includes the claims) and/or shown in the drawings may be incorporated in the invention independently of (or in combination with) any other disclosed and/or illustrated features. In particular but without limitation the features of any of the claims dependent from a particular independent claim may be introduced into that independent claim in any combination or individually.

### BRIEF DESCRIPTION OF DRAWINGS

Embodiments of the invention will now be described, by way of example, with reference to the accompanying drawings in which:

FIG. 1 illustrates schematically a mobile (cellular or wireless) telecommunication system to which embodiments of the invention may be applied;

FIG. 2 illustrates schematically an exemplary way in which resiliency may be provided in the system shown in FIG. 1;

FIG. 3 is a block diagram of a User Equipment (UE) forming part of the system shown in FIG. 1;

FIG. 4 is a block diagram of a base station forming part of the system shown in FIG. 1;

FIG. 5 is a block diagram of a core network node (or function) forming part of the system shown in FIG. 1;

FIG. 6 is schematic signalling (timing) diagrams illustrating exemplary ways in which embodiments of the invention can be implemented in the system of FIG. 1;

FIG. 7 is schematic signalling (timing) diagrams illustrating exemplary ways in which embodiments of the invention can be implemented in the system of FIG. 1; and

FIG. 8 is schematic signalling (timing) diagrams illustrating exemplary ways in which embodiments of the invention can be implemented in the system of FIG. 1.

### DESCRIPTION OF EMBODIMENTS

### Overview

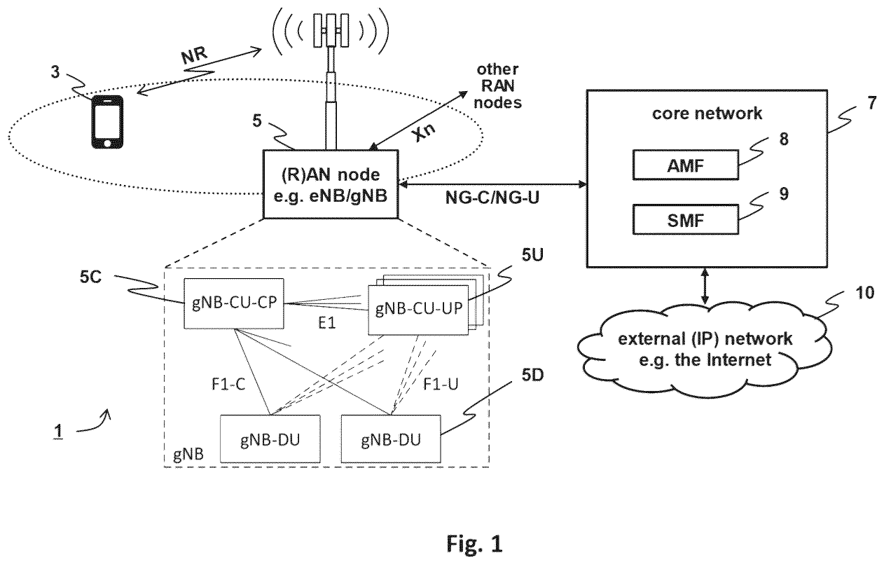

FIG. 1 schematically illustrates a mobile (cellular or wireless) telecommunication system 1 to which embodiments of the present invention are applicable.

In this network, users of mobile devices 3 (UEs) can communicate with each other and other users via respective base stations 5 and a core network 7 using an appropriate 3GPP radio access technology (RAT), for example, a 5G RAT. It will be appreciated that a number of base stations 5 form a (radio) access network or (R)AN. As those skilled in the art will appreciate, whilst one mobile device 3 and one base station 5 are shown in FIG. 1 for illustration purposes, the system, when implemented, will typically include other base stations and mobile devices (UEs).

Each base station 5 controls one or more associated cells (either directly or via other nodes such as home base stations, relays, remote radio heads, distributed units, and/or the like). A base station 5 that supports Next Generation/5G protocols may be referred to as a ‘gNB’. It will be appreciated that some base stations 5 may be configured to support both 4G and 5G, and/or any other 3GPP or non-3GPP communication protocols.

As shown in FIG. 1, the functionality of a gNB 5 (referred to herein as a ‘distributed’ gNB) may be split between one or more distributed units (DUs) and a central unit (CU) with a CU typically performing higher level functions and communication with the next generation core and with the DU performing lower level functions and communication over an air interface with UEs 3 in the vicinity (i.e. in a cell operated by the gNB 5). In this example, the distributed gNB 5 includes the following functional units or logical nodes: i) gNB Central Unit (gNB-CU) which may be further split into a gNB-CU-Control Plane unit 5C (gNB-CU-CP) and one or more gNB-CU-User Plane units 5U (gNB-CU-UPs), and ii) one or more gNB Distributed Units 5D (gNB-DUs).

The gNB-CU-CP 5C and each gNB-CU-UP 5U are coupled via the E1 interface (E1AP). The gNB-CU and each gNB-DU 5D are coupled via the F1 interface (F1AP) between them. The gNB-CU-CP 5C and the gNB-DUs 5D are coupled via the F1-C(F1 control plane) interface, whilst the gNB-CU-UP 5U and respective gNB-DUs 5D are coupled via the F1-U (F1 user plane) interface.

The gNB-CU-CP 5C hosts the RRC protocol and the control plane part of the PDCP protocol of the gNB-CU for an en-gNB or a gNB. The gNB-CU-UP 5U hosts the user plane part of the PDCP protocol and the SDAP protocol of the gNB-CU for a gNB (SDAP not applicable in case of an en-gNB). Each gNB-DU 5D supports at least one cell (however, each cell is supported by only one gNB-DU 5D).

The mobile device 3 and its serving base station 5 are connected via an appropriate air interface (for example the so-called ‘NR’ air interface, the ‘Uu’ interface, and/or the like). Neighbouring base stations 5 are connected to each other via an appropriate base station to base station interface (such as the so-called ‘Xn’ interface, the ‘X2’ interface, and/or the like). The base station 5 is also connected to the core network nodes via an appropriate interface (such as the so-called ‘NG-U’ interface (for user-plane), the so-called ‘NG-C’ interface (for control-plane), and/or the like).

The core network 7 typically includes logical nodes (or ‘functions’) for supporting communication in the telecommunication system 1. Typically, for example, the core network 7 of a ‘Next Generation’/5G system will include, amongst other functions, control plane functions (CPFs) and user plane functions (UPFs). For example, the core network 7 may include at least an Access and Mobility management Function (AMF) 8 and a Session Management Function (SMF) 9. From the core network 7, connection to an external IP network 10 (such as the Internet) may also be provided.

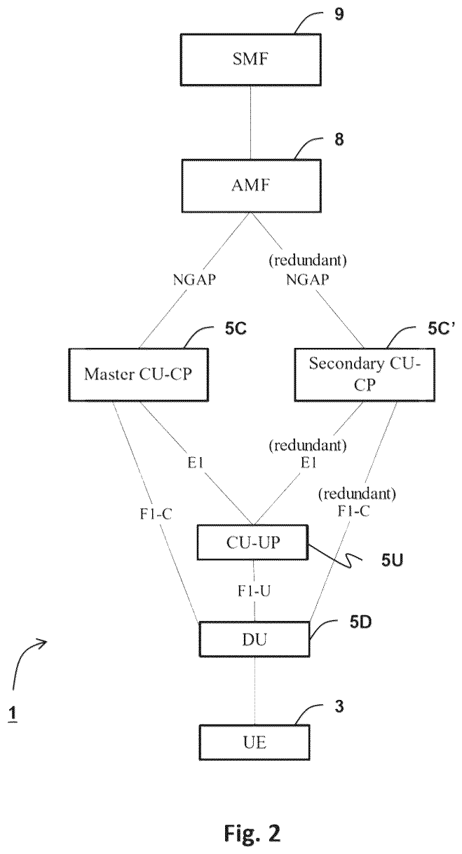

FIG. 2 illustrates schematically the components of the distributed base station and the other nodes, including the interfaces therebetween, once a resiliency configuration is in place. In more detail, the UE 3 is served by a DU 5D (at least one DU) using an appropriate air interface (in case of a wireless UE). The DU 5D is connected to the CU-UP 5U via the F1-U interface (user plane), and connected to an associated (main or master) CU-CP 5C via the F1-C interface (control plane). The CU-CP 5C and the CU-UP 5U are connected via the E1 interface. The CU-CP 5C is connected to the core network (AMF 8) via the NG interface (NGAP in FIG. 2).

The main (or initial) CU-CP 5C will be referred to as the master CU-CP 5C in the following. As discussed above, the master CU-CP 5C may become a single point of failure. In order to provide resiliency for this scenario, in this system a further CU-CP 5C′ is set up as well acting as a backup node in case the master CU-CP 5C fails. The further CU-CP 5C′ will be referred to as a second or secondary CU-CP 5C′ in the following. Accordingly, as shown in FIG. 2, redundant F1/E1/NG connections are set up via the secondary CU-CP 5C′, although these connections may not be used initially. It will be appreciated that (at least some of) the redundant connections may be in place before any UE 3 is connected to the main CU-CP 5C (or during a procedure for connecting the first UE 3).

There are various ways in which these redundant connections may established to a secondary CU-CP 5C′. For example, the master CU-CP 5C may configure an appropriate resilient CU-CP 5C′ as part of an E1 setup procedure or an F1 setup procedure (alternatively, an E1 or F1 modification procedure). The resiliency configuration may beneficially include an address (TNL address) and the name of the secondary CU-CP 5C′ and an associated failure timer (or any other suitable assistance information for determining CU-CP failure). In this case, the address and the name are used by the nodes (the CU-UP 5U and the DU 5D) to set up appropriate resilient connections with the secondary CU-CP 5C′, and the failure time/assistance information is used during operation to determine whether the resilient connections need to be activated (i.e. in the event of CU-CP failure).

Beneficially, the CU-UP 5U and the DU 5D may obtain the address and name of the secondary CU-CP 5C′ and obtain an associated failure timer from the master CU-CP 5C or from another node (e.g. OAM). The CU-UP/DU and the master CU-CP 5C may use existing messages with new information elements indicating at least one of the address, name, and failure timer associated with the secondary CU-CP 5C′. Alternatively, dedicated messages may be used to deliver some or all of this information to the CU-UP 5C and the DU 5D.

In order to achieve a timely and efficient recovery from failure of the master CU-CP 5C, the relevant UE contexts are backed up so that they can be retrieved and used by the secondary CU-CP 5C′ without delay or data loss and without requiring excessive signalling. Specifically, the relevant UE context(s) may be backed up at a secondary CU-CP (or an AMF/SMF etc.) upon setting up/modifying/releasing the UE context(s) at the master CU-CP. Alternatively, a similar procedure may be used upon failure (or overload) of the master CU-CP to migrate the relevant UE contexts to a secondary CU-CP (optionally AMF/SMF). Accordingly, the backup/migrated UE context(s) may be used by the secondary CU-CP 5C′ and the other nodes to recover UE service after failure of the master CU-CP (or overload).

Beneficially, when one of network entities (e.g. DU 5D or CU-UP 5U) detects breakdown of the serving CU-CP 5C, it activates CU-CP resiliency by sending an appropriate activation message to the secondary CU-CP 5C′. The secondary CU-CP 5C′ takes over the control of UE(s) 3 and notifies the relative entities so that they can apply the appropriate resiliency configuration.

Beneficially, the above solutions require relatively low amount of signalling towards UEs and the network during gNB-CU-CP failure recovery. At the same time, user plane interruptions/service downtime from the end-user perspective are kept to the minimum, with minimum control plane interruptions.

### Mobile Device

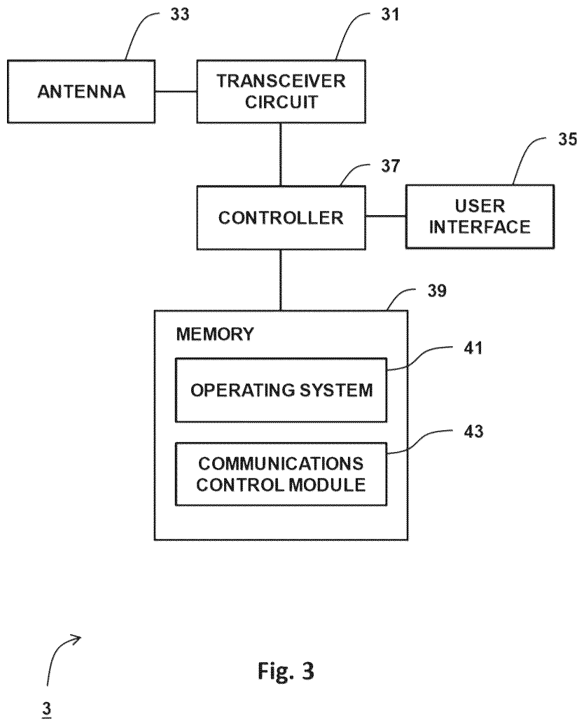

FIG. 3 is a block diagram illustrating the main components of the mobile device 3 shown in FIG. 1 (e.g. a mobile telephone or an IoT device). As shown, the mobile device 3 has a transceiver circuit 31 that is operable to transmit signals to and to receive signals from a base station 5 via one or more antenna 33. The mobile device 3 has a controller 37 to control the operation of the mobile device 3. The controller 37 is associated with a memory 39 and is coupled to the transceiver circuit 31. Although not necessarily required for its operation, the mobile device 3 might of course have all the usual functionality of a conventional mobile telephone (such as a user interface 35) and this may be provided by any one or any combination of hardware, software and firmware, as appropriate. Software may be pre-installed in the memory 39 and/or may be downloaded via the telecommunications network or from a removable data storage device (RMD), for example.

The controller 37 is configured to control overall operation of the mobile device 3 by, in this example, program instructions or software instructions stored within memory 39. As shown, these software instructions include, among other things, an operating system 41, and a communications control module 43.

The communications control module 43 is operable to control the communication between the mobile device 3 and its serving base station 5 (and other communication devices connected to the serving base station 5, such as other user equipment, core network nodes, etc.).

It will be appreciated that the communications control module 43 may include a number of sub-modules (or ‘layers’) to support specific functionalities. For example, the communications control module 43 may include a Physical (PHY) layer sub-module, a Medium Access Control (MAC) sub-module, a Radio Link Control (RLC) sub-module, a Packet Data Convergence Protocol (PDCP) sub-module, a Service Data Adaptation Protocol (SDAP) sub-module, an Internet Protocol (IP) sub-module, a Radio Resource Control (RRC) sub-module, a Non-Access Stratum (NAS) sub-module, etc.

### Base Station

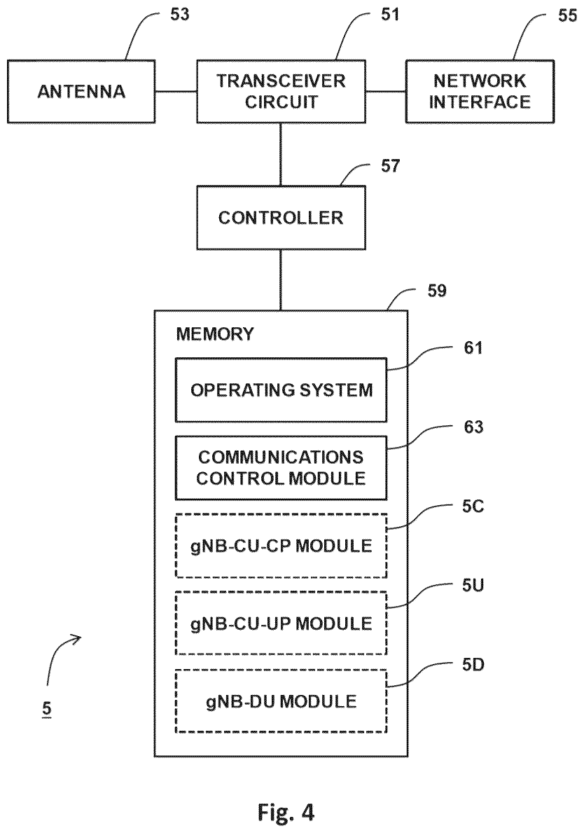

FIG. 4 is a block diagram illustrating the main components of a distributed base station 5 shown in FIG. 1. As shown, the base station 5 has a transceiver circuit 51 for transmitting signals to and for receiving signals from user equipment (such as the mobile device 3) via one or more antenna 53, a network interface 55 (e.g. NG-C/NG-U interface, and/or the like) for transmitting signals to and for receiving signals from the core network 7, and a base station interface 56 (e.g. Xn interface, and/or the like) for transmitting signals to and for receiving signals from neighbouring base stations. The base station 5 has a controller 57 to control the operation of the base station 5 in accordance with software stored in a memory 59. The software may be pre-installed in the memory 59 and/or may be downloaded via the telecommunication network 1 or from a removable data storage device (RMD), for example. The software includes, among other things, an operating system 61, and at least a communications control module 63. Although not shown in FIG. 3, the network interface 55 will also typically include a base station to base station interface module (e.g. Xn), and a core network interface module (e.g. NG-C/NG-U).

The communications control module 63 is responsible for handling (generating/sending/receiving) signalling between the base station 5 and other nodes, such as the UE 3 and the core network nodes. Such signalling may include, for example, control data for managing operation of the mobile device 3 (e.g. NAS, RRC, paging, system information, and/or the like). It will be appreciated that the communications control module 63 may include a number of sub-modules (or ‘layers’) to support specific functionalities. For example, the communications control module 63 may include a PHY sub-module, a MAC sub-module, an RLC sub-module, a PDCP sub-module, an SDAP sub-module, an IP sub-module, an RRC sub-module, etc.

When the base station 5 comprises a distributed gNB or en-gNB, the network interface 55 also includes an E1 interface and an F1 interface (F1-C for the control plane and F1-U for the user plane) to communicate signals between respective functions of the distributed gNB or en-gNB. In this case, the software also includes at least one of: a gNB-CU-CP module 5C, a gNB-CU-UP module 5U, and a gNB-DU module 5D. If present, the gNB-CU-CP module 5C hosts the RRC layer and the control plane part of the PDCP layer of the distributed gNB or en-gNB. If present, the gNB-CU-UP module 5U hosts the user plane part of the PDCP and the SDAP layers of the distributed gNB or the user plane part of the PDCP layer of the distributed en-gNB. If present, the gNB-DU module 5D hosts the RLC, MAC, and PHY layers of the distributed gNB or en-gNB.

It will be understood by a person skilled in the art that the central unit (e.g. 5C and/or 5U) may be implemented and physically located with the base station or may be implemented at a remote location, as a single physical element or as a cloud-based or Virtualized system. It will also be understood that a single central unit may serve multiple base stations 5.

### Core Network Node

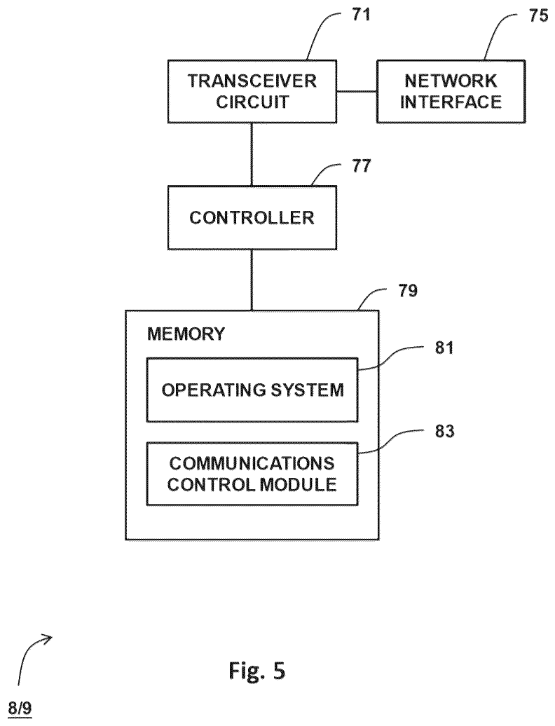

FIG. 5 is a block diagram illustrating the main components of a generic core network node (or function) shown in FIG. 1, for example, the AMF 8 or the SMF 9. As shown, the core network node includes a transceiver circuit 71 which is operable to transmit signals to and to receive signals from other nodes (including the UE 3 and the (R)AN node 5) via a network interface 75. A controller 77 controls the operation of the core network node in accordance with software stored in a memory 79. The software may be pre-installed in the memory 79 and/or may be downloaded via the telecommunication network 1 or from a removable data storage device (RMD), for example. The software includes, among other things, an operating system 81 and at least a communications control module 83. The communications control module 83 is responsible for handling (generating/sending/receiving) signaling between the core network node and other nodes, such as the UE 3, the (R)AN node 5, and other core network nodes.

### Operation

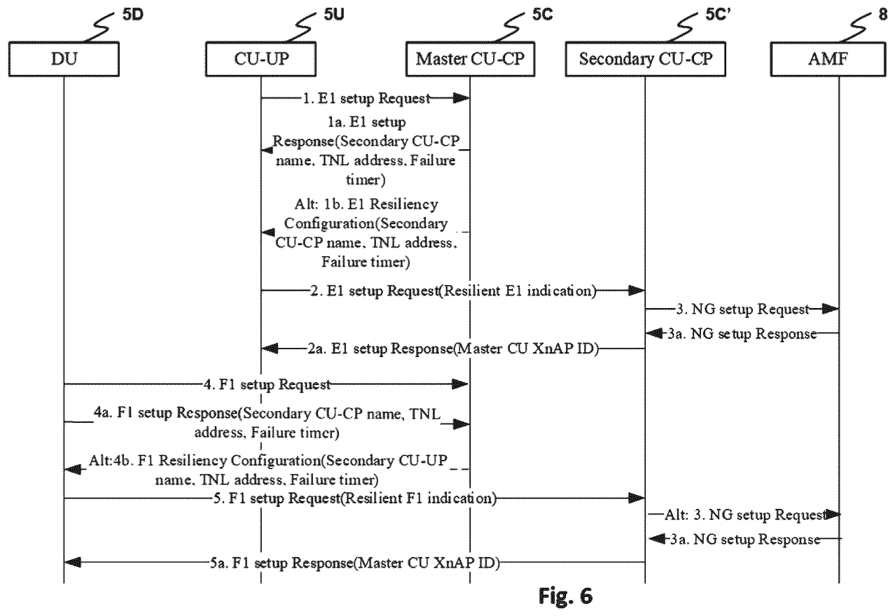

As discussed above, the system 1 includes a distributed base station apparatus 5 serving a number of UEs 3 via one or more distributed units 5D (denoted ‘gNB-DU’ in FIG. 1 and ‘DU’ in FIGS. 2 and 6). The central unit (CU) portion of the distributed base station apparatus 5 is responsible for controlling control plane and user plane operation relating to the UEs 3. The user plane portion of the central unit is referred to as CU-UP 5U (or ‘gNB-CU-UP’ in FIG. 1), which is effectively a logical node hosting the user plane part of the PDCP protocol of the distributed base station apparatus 5 (and the SDAP protocol if appropriate). The control plane portion of the central unit is referred to as CU-CP 5C (or ‘gNB-CU-CP’ in FIG. 1), which is effectively a logical node hosting the RRC protocol and the control plane part of the PDCP protocol of the distributed base station apparatus 5.

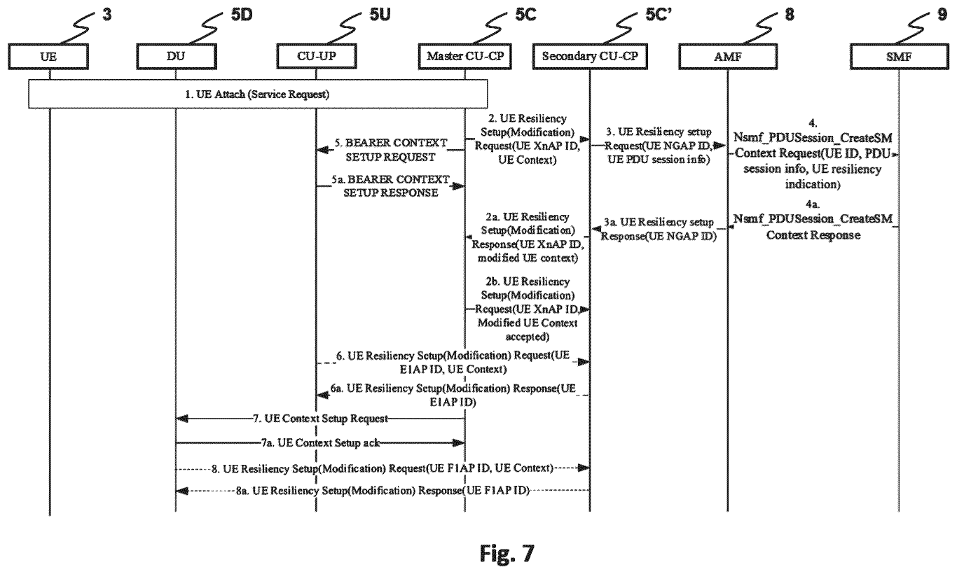

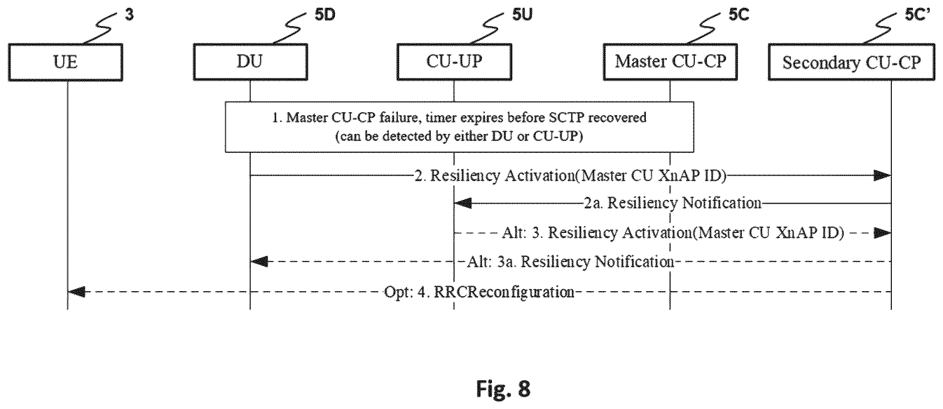

A more detailed description will now be given (with reference to FIGS. 6 to 8) of various aspects of resiliency in the system shown in FIGS. 1 and 2. In more detail, FIG. 6 illustrates schematically an exemplary procedure for establishing redundant connections to a secondary node (in this case E1/F1/NG connections), FIG. 7 illustrates schematically an exemplary UE context backup procedure, and FIG. 8 illustrates schematically an exemplary procedure for resiliency activation.

### Redundant Connections

FIG. 6 illustrates schematically some possible ways in which redundant connections may established to a secondary CU-CP 5C′. It will be appreciated that (at least a part of) the procedure may be performed before any UE 3 is connected to the main CU-CP 5C or during a procedure for connecting the first (or second etc.) UE 3.

Specifically, the steps illustrated in FIG. 6 may be applied to at least one of the following: i) establishment of a redundant E1 connection between the CU-UP 5U and a secondary CU-CP 5C′; ii) establishment of a redundant F1 (control plane) connection between the DU 5D and the secondary CU-CP 5C′; and iii) establishment of a redundant NG connection between the AMF 8 and the secondary CU-CP 5C′. It will also be appreciated that the same (or similar) procedures may be used to change or re-establish one or more existing connection when appropriate.

In FIG. 6 an exemplary E1 setup procedure is illustrated steps 1, 1a, 1b, 2, and 2a, an exemplary NG setup procedure is illustrated steps 3 and 3a, and an exemplary F1 setup procedure is illustrated steps 4, 4a, 4b, 5, and 5a. It will be appreciated that the E1/NG/F1 procedures may be performed in a different order (and/or independently from each other).

In this example, the procedure starts with E1 setup between the CU-UP 5U and the master CU-CP 5C. As can be see, in step 1, the CU-UP 5U generates and transmits (using its associated communications control module 63) an appropriately formatted message for initiating E1 setup between the CU-UP 5U and a CU-CP 5C (which will act as the master CU-CP). The CU-CP 5C may be selected based on information provided by the UE 3, the AMF 8, and/or any other node, if appropriate.

If the (master) CU-CP 5C is able to accept this connection request, it will generate and transmit an appropriate response (e.g. ‘E1 Setup Response’) to the CU-UP 5U. In one option, as generally shown in step 1a, the CU-CP 5C may be configured to include in this message appropriate information related to a suitable redundant/secondary CU-CP 5C′. For example, the E1 Setup Response message (or similar) may include one or more of the following: the name of at least one redundant/secondary CU-CP 5C′; the respective Transport Network Layer (TNL) address(es) of the at least one redundant/secondary CU-CP 5C′; and information identifying a timer associated with the at least one redundant/secondary CU-CP 5C′. In another option, as generally shown in step 1b, the CU-CP 5C may be configured to include the above information in a different message (e.g. a message transmitted after the E1 Setup Response message). In this case, the E1 Setup Response message in step 1a does not need to include this information. However, it will be appreciated that the message transmitted in step 1b may be used to update or supplement any information included in the E1 Setup Response message. The message transmitted in step 1b may comprise a subsequent E1 Setup Response message or a message relating to E1 reconfiguration or E1 modification (e.g. an E1 Reconfiguration/Modification Request, or an associated response message).

In step 2, the CU-UP 5U initiates a procedure for establishing a resilient E1 tunnel based on the information received in step 1a/1b. Specifically, the CU-UP 5U generates and transmits (using its associated communications control module 63) an appropriately formatted message for initiating E1 setup between the CU-UP 5U and the CU-CP 5C′ identified in step 1a/1b (which will act as the secondary CU-CP for the CU-UP 5U). The message may include information indicating that the E1 setup is for the purpose of providing resiliency (e.g. a suitable ‘Resilient E1’ indication and/or the like). The resiliency indication may be provided for example using a suitable information element or a flag. The message may also include information identifying the master CU-CP 5C which may be used for establishing/configuring a connection (e.g. Xn) between the master CU-CP 5C and the secondary CU-CP 5C′ (not shown in FIG. 6).

In step 2a, the secondary CU-CP 5C′ accepts the E1 setup request and provides its own identifier associated with the master CU-CP 5C (e.g. an appropriate ‘Master CU XnAP ID’ and/or the like) for use by the other nodes to identify the master CU-CP 5C in the event of a failure and to activate the resilient connections if needed.

Steps 3 and 3a illustrate an exemplary procedure for connecting the secondary CU-CP 5C′ to an AMF 8 that serves the master CU-CP 5C (or another suitable AMF 8). In this example, the NG Setup Request/Response messages are used although it will be appreciated that other suitable messages may be used when appropriate (NG Modification Request/Response messages and/or the like). As can be seen, steps 3 and 3a may be performed in response to the establishment of the resilient E1 tunnel (after step 2) or at another time (e.g. as part of a procedure for connecting the secondary CU-CP 5C′ to a distributed unit 5D serving the master CU-CP 5C (after step 5). In other words, connection establishment/modification between the secondary CU-CP 5C′ and the AMF 8 may be triggered by a message from the CU-UP 5U or a message from the DU 5D. Alternatively, although not shown in FIG. 6, the master CU-CP 5C may be configured to transmit (e.g. via Xn) a message to the secondary CU-CP 5C′ for triggering connection establishment/modification between the secondary CU-CP 5C′ and the AMF 8.

The following is a description of the procedures relating to establishment of the F1 connections to support resiliency for the distributed base station apparatus 5. As illustrated in step 4, the DU 5D initiates setting up of an appropriate connection with the first (master) CU-CP 5C by generating and sending (using its associated communications control module 63) an F1 Setup Request to the CU-CP 5C. It will be appreciated that this request may include an appropriate indication whether the DU 5D requires (or supports) a redundant F1 tunnel, although such indication may be entirely optional (or implicit).

As illustrated in step 4a, the first (master) CU-CP 5C responds by generating and sending (using its associated communications control module 63) an appropriately formatted F1 Setup Response. In this case, the response includes one or more of the following: the name of at least one redundant/secondary CU-CP 5C′; the respective TNL address(es) of the at least one redundant/secondary CU-CP 5C′; and information identifying a timer associated with the at least one redundant/secondary CU-CP 5C′. In another option, as generally shown in step 4b, the CU-CP 5C may be configured to include the above information in a different message adapted to provide F1 resiliency configuration (transmitted after the F1 Setup Response message). In this case, the F1 Setup Response message in step 4a does not need to include this information (or may include only a part of it). However, it will be appreciated that the message transmitted in step 4b may be used to update or supplement any information included in the F1 Setup Response message. The message transmitted in step 4b may comprise a subsequent F1 Setup Response message or a message relating to F1 reconfiguration or F1 modification (e.g. an F1 Reconfiguration/Modification Request, or an associated response message).

Based on the information received in step 4a/4b, the DU 5D initiates a procedure for establishing a resilient F1 connection. Specifically, the DU 5D generates and transmits (using its associated communications control module 63) an appropriately formatted message for initiating F1 setup between the DU 5D and the CU-CP 5C′ identified in step 4a/4b (which will act as the secondary CU-CP for the DU 5D). The message may include information indicating that the F1 setup is for the purpose of providing resiliency (e.g. a suitable ‘Resilient F1’ indication and/or the like). The resiliency indication may be provided for example using a suitable information element or a flag. The message may also include information identifying the master CU-CP 5C which may be used for establishing/configuring a connection (e.g. Xn) between the master CU-CP 5C and the secondary CU-CP 5C′ (not shown in FIG. 6).

In step 5a, the secondary CU-CP 5C′ accepts the F1 setup request and provides its own identifier associated with the master CU-CP 5C (e.g. an appropriate ‘Master CU XnAP ID’ and/or the like).

In summary, the above procedures make it possible to establish/configure appropriate connections to a secondary CU-CP 5C′ which can act as a redundant node for the master CU-CP 5C in case the master CU-CP 5C fails (or when it is overloaded). Beneficially, redundant E1/F1/NG connections to the secondary CU-CP 5C′ may be established before any UE 3 is connected to the master CU-CP 5C (or in any case before the master CU-CP 5C fails or becomes overloaded).

For sake of completeness, it will be appreciated that the establishment of any of the redundant connections (E1/NG/F1 in steps 2, 3, and 5, respectively) may be performed any time after the secondary CU-CP 5C′ name/TNL address/failure timer is sent from the master CU-CP 5C (or known otherwise). Moreover, it will be appreciated that steps 2, 3, and 5 do not need to be in any particular order. For example, the messages in steps 2 and 4 may be sent substantially simultaneously. As shown, step 3 (resilient NG setup) may be triggered by either step 2 or 5 or both (i.e. by any message including an indication associated with a resilient connection involving the CU-CP 5C′). It will also be appreciated that step 5 (resilient F1 establishment) may be triggered by the initial F1 establishment (i.e. steps 4/4a/4b) even before completion of the initial F1 establishment. As discussed above, steps 1b and 4b are optional. They may be used in a case that the messages in steps 1a and 3a do not include information relating to the secondary CU-CP 5C′ or when such information needs to be updated.

Regarding the TNL address, secondary CU-CP name, failure timer, it will be appreciated that the CU-CP 5C or DU 5D may obtain any of this information using a message forming part of the F1/E1 setup procedure (as in steps 1/4) or any other suitable message (as in steps 1a/4a). The information (or at least a part of it) may also be obtained from other sources, e.g. OAM.

### UE Context Backup

FIG. 7 is a schematic timing (signalling) diagram illustrating an exemplary procedure for UE context backup for improved resiliency of a distributed base station.

The procedure may be employed for at least one of the following purposes (amongst others):
backing up a UE context at a secondary CU-CP/AMF/SMF for example in a case the UE context is being setup/modified/released at the master CU-CP, in order to be able to recover UE service upon failure of the master CU-CP (or overload); and
migrating all UE contexts associated with a serving (master) CU-CP to a secondary CU-CP (optionally AMF/SMF) when the serving CU-CP experiences a failure (or overload).

It will be appreciated that the second case may involve a relatively large amount of signalling messages, substantially at the same time. Nevertheless, if PDCP configuration is negotiated between the master CU-CP and the secondary CU-CP, transmission of RRCReconfiguration messages towards the UEs may not be necessary.

Turning now to the specific procedures illustrated in FIG. 7, the following main options are envisaged (amongst others):
the master CU-CP may initiate establishment or modification of a redundant UE context using a secondary CU-CP (step 2);
the CU-UP may initiate establishment or modification of a redundant UE context using the secondary CU-CP (step 6); and
the DU may initiate establishment or modification of a redundant UE context using the secondary CU-CP (step 8).

It will be appreciated that initially at least one UE 3 is connected to the master CU-CP 5C (and to the other units of the distributed base station), after performing an appropriate UE attach procedure (as generally shown in step 1).

In step 2, after (or in response to) the UE attach/service request from the UE 3, the master CU-CP 5C generates and sends (using its associated communications control module 63) an appropriately formatted signalling message for backing up the UE context(s) associated with the connected UE(s) 3. In this example, the master CU-CP 5C transmits the signalling message over a base station to base station interface such as the Xn interface. It will be appreciated that step 2 may be performed for each newly connected UE 3, for a group of UEs (e.g. when a minimum number of UEs is reached), and/or periodically (e.g. after expiry of an associated timer). In this example, the master CU-CP 5C transmits a ‘UE Resiliency Setup Request’ message (or a ‘UE Resiliency Modification Request’ message) to a secondary CU-CP 5C′. The message includes information identifying the UE(s) (e.g. by their associated UE XnAP ID and/or the like) and the corresponding UE context(s). It will also be appreciated that similar UE context backup may be initiated by another node, as discussed later with reference to steps 6 and 8, using similar UE Resiliency Setup/Modification Request messages or any other suitable message.

If the secondary CU-CP 5C′ can accept the request from the master CU-CP 5C, it generates and sends an appropriate response (e.g. a ‘UE Resiliency Setup Response’ a ‘UE Resiliency Modification Response’). If the secondary CU-CP 5C′ cannot accept the request from the master CU-CP 5C, it generates and sends an appropriate ‘UE Resiliency Setup Failure’ or a ‘UE Resiliency Modification Failure’ message to the master CU-CP 5C and includes an appropriate error cause (not shown in FIG. 7).

When the master CU-CP 5C sends the UE context(s) to the secondary CU-CP 5C′ in step 2, it may also include the applicable PDCP configuration in the UE context (for each UE). However, if the secondary CU-CP 5C′ does not (or cannot) accept a UE context with a particular PDCP configuration, then the secondary CU-CP 5C′ may be configured to return an appropriate message identifying that particular UE context (by its UE XnAP ID) and may include a modified (supported) UE context/PDCP configuration, if appropriate. For example, the secondary CU-CP 5C′ may determine that it does not support a particular PDCP configuration (e.g. due to an unsupported encryption algorithm, header compression algorithm, etc.). In this case, as generally shown in step 2a, the secondary CU-CP 5C′ may send a modified UE context(s) with a supported PDCP configuration to the master CU-CP 5C. If the master CU-CP 5C accepts the PDCP configuration provided in step 2a, it notifies the secondary CU-CP 5C′ (e.g. by sending a UE Resiliency Setup/Modification Request accepted message) and includes the relevant UE XnAP ID(s) and the accepted (modified) UE context(s). If the master CU-CP 5C does not accept the PDCP configuration provided in step 2a, it sends a rejection message to the secondary CU-CP 5C′ (e.g. a UE Resiliency Setup/Modification Request rejected message) including the UE XnAP ID(s) relating to the rejected UE Context(s). It will be appreciated that the PDCP configuration may also be referred to as an RRC context (including appropriate PDCP, RLC, MAC, PHY configuration). Although not shown in FIG. 7, the master CU-CP 5C may be configured to select a different secondary node for any rejected UE context to ensure resiliency with respect to those UEs as well (i.e. to backup any such UE context at a different node).

After the secondary CU-CP 5C′ has been selected for resiliency (backup/redundancy) with respect to at least one UE 3 (at least one UE context), it proceeds to generate and send (using its associated communications control module 63) an appropriately formatted signalling message to the AMF 8, in step 3. This message (for example a ‘UE Resiliency Setup Request’ message) is for notifying the AMF 8 (and other relevant core network nodes, if any) about the selection of the secondary CU-CP 5C′ for resiliency and for initiating setting up of an appropriate NG connection between the AMF 8 and the secondary CU-CP 5C′ (and the UE 3). This message may use UE associated signalling and may include an identifier associated with the UE 3 (e.g. UE NGAP ID or a similar identifier used by the secondary CU-CP 5C′). The message may also include information relating to the Protocol Data Unit (PDU) session(s) for the UE 3, although it will be appreciated that a default PDU session may be used instead (e.g. in the absence of any PDU session information). Effectively, each PDU session corresponds to a respective PDU session included in the received UE context. The secondary CU-CP 5C′ may need to establish these PDU sessions (or at least a default PDU session) so that the UE(s) 3 can continue communicating using the secondary CU-CP 5C′ without interruption in the event that the master CU-CP 5C fails.

As generally shown in step 4, the AMF 8 requests the SMF 9 to create an associated session management context for resiliency. The request (e.g. an ‘Nsmf_PDUSession_CreateSMContext Request’) includes information identifying the UE 3 that the request relates to and information indicating the reason for this request (resiliency). The indication may be provided for example using a suitable information element or a flag. As shown in step 4a, the SMF 9 confirms that it has created a session management context for resiliency by sending an appropriately formatted response (e.g. ‘Nsmf_PDUSession_CreateSMContext Response’ and/or the like). In case the master CU-CP 5C fails, the SMF 9 will switch the associated path to the secondary CU-CP 5C′ (e.g. as part of the procedure described with reference to FIG. 8). The SMF 9 knows which CU-CP is the resilient node and which PDU session to use from the “UE resiliency indication” included in message 4 of FIG. 7.

Next, the AMF 8 generates and sends (using its communications control module 83) an appropriately formatted signalling message to the secondary CU-CP 5C′, in step 3a. This message (for example a ‘UE Resiliency Setup Response’ message) completes setting up of the NG connection between the AMF 8 and the secondary CU-CP 5C′ (and the UE 3). The message includes an appropriate UE identifier (UE NGAP ID). It will be appreciated that after step 3a the secondary CU-CP 5C′ may also send an appropriate confirmation to the master CU-CP 5C (similar to step 2a) indicating that it is ready to serve the master CU-CP 5C as a redundant node.

Turning now to the case of UE context backup initiated by the CU-UP 5U, it will be appreciated that the message transmitted in step 6 is similar to the message described above with reference to step 2. However, in this case the CU-UP 5U uses its own UE identifier such as the so-called ‘UE E1AP ID’. In case of successful UE context backup the secondary CU-CP 5C′ generates and sends an appropriate response to the CU-UP 5U in step 6a (and it may also proceed to step 3, if applicable).

Finally, step 8 illustrates a UE context backup procedure initiated by the DU 5D. It will be appreciated that the message transmitted in step 8 and the response in step 8a are similar to the messages described above with reference to steps 2 and 2a, respectively. However, in this case the DU 5D uses its own UE identifier such as the so-called ‘UE F1AP ID’. After successful UE context backup the secondary CU-CP 5C′ may also proceed to step 3, if applicable.

For sake of completeness, FIG. 7 also shows an exemplary bearer context setup procedure (steps 5 and 5a) between the master CU-CP 5C and the CU-UP 5U, for setting up appropriate bearers for the UE 3. FIG. 7 also shows an exemplary UE context setup procedure (steps 7 and 7a) between the master CU-CP 5C and the DU 5D, for setting up an associated UE context at the distributed unit serving the UE 3.

It will be appreciated that step 2, step 5, and/or step 7 may be performed substantially simultaneously. In any case, the various procedures shown in FIG. 7 do not need to be performed in a particular order. UE resiliency may be established (or modified) either by step 2, step 6, or step 8. In other words, UE resiliency may be established and/or modified by the master CU-CP 5C, the CU-UP 5U, or the DU 5U. It will be appreciated that if the UE context (e.g. a (data or signalling radio bearer) is modified, the message in step 6/8/10 may be a UE Resiliency Modification Request. Step 3 (and subsequent step 4) may be triggered by any of step 2, step 6, and step 8 (since they are alternatives). Thus, regardless of which node requests the secondary CU-CP 5C′ to act as a redundant unit for resiliency, the secondary CU-CP 5C′ can update the relevant core network nodes accordingly.

### CU-CP Resiliency Activation

FIG. 8 illustrates schematically an exemplary procedure for activating a resilient CU-CP (and activating any backup UE context held by the resilient CU-UP) in the event of a failure of the serving CU-CP (master CU-CP).

As generally shown in step 1, failure of the master CU-CP 5C may be detected by either the associated DU 5D or CU-UP 5U due to failure associated with the Stream Control Transmission Protocol (SCTP) with respect to at least one UE 3. For example, failure may be detected based on expiry of an associated timer, such as the ‘failure timer’ described above with reference to FIG. 6.

In this example, the DU 5D determines in step 1 that the failure timer associated with the master CU-CP 5C has expired before it was able to recover from an SCTP failure. Accordingly, when the DU 5D determines that the SCTP problem lasted longer than the allowed maximum duration as per the associated failure timer, it generates and transmits in step 2 (using its associated communications control module 63) an appropriately formatted message to the secondary CU-CP 5C′ for activating resiliency. Alternatively, as generally shown in step 3, the CU-UP 5U may determine failure of the master CU-CP 5C (based on an associated failure timer) and transmit a message to the secondary CU-CP 5C′ for activating resiliency.

The DU 5D/CU-UP 5U includes in its message an identifier of the master CU-CP 5C (Master CU XnAP ID and/or the like) to indicate which node is deemed to have failed so that the secondary CU-CP 5C′ can retrieve the associated UE context(s). In step 2a/3a, the secondary CU-CP 5C′ indicates that it is now acting as the new serving CU-CP. Specifically, the secondary CU-CP 5C′ generates and transmits an appropriate ‘Resiliency Notification’ message (and/or the like) to the CU-UP 5U (if the message in step 2 was transmitted by the DU 5D) or the DU 5D (if the message in step 3 was transmitted by the CU-UP 5U). It will be appreciated that the secondary CU-CP 5C′ may notify both the DU 5D and the CU-UP 5U. In other words, both steps 2a and 3a may be performed after either step 2 or step 3. Effectively, the message in step 2a/3a (which may be any suitable message) serves as an indication to the corresponding node(s) that resiliency has been activated (and/or an indication that the master node has failed) so that they can apply the associated resiliency configuration.

Effectively, from this point the secondary CU-CP will act as the new master CU-CP for the relevant UEs 3. If appropriate, the new master CU-CP may proceed to perform any of the procedures described above with reference to FIGS. 6 and 7 to ensure that a new resilient CU-CP is in place and to perform appropriate UE context backup. Although not shown in FIG. 8, it will be appreciated that the SMF 9 will switch the associated path/PDU session to the secondary CU-CP 5C′, as configured in messages 4 and 4a of FIG. 7.

If necessary, RRC reconfiguration may take place between the new CU-CP 5C′ and the UE 3. However, it will be appreciated that this step may be omitted if the master and secondary CU-CPs use the same PDCP configuration (e.g. if they both support the original PDCP configuration or if they agreed on an appropriate (supported) PDCP configuration/RRC context as discussed above with reference to steps 2a and 2b of FIG. 7).

In summary, when one of network entities detects the breakdown of the serving CU-CP, it activates the CU-CP resiliency. The secondary CU-CP takes over the control of UE(s) and notifies the relative entities so that they can apply the appropriate resiliency configuration.

### Modifications and Alternatives

Detailed embodiments have been described above. As those skilled in the art will appreciate, a number of modifications and alternatives can be made to the above embodiments whilst still benefiting from the inventions embodied therein. By way of illustration only a number of these alternatives and modifications will now be described.

Regarding step 1 of FIG. 8, it will be appreciated that a relatively short SCTP error from which the DU/CU-UP is able to recover before expiry of the failure timer may not trigger a CU-CP resiliency procedure. Thus, by setting (agreeing on) the value of the failure timer the DU/CU-UP and the master CU-CP are able to control how much data loss is acceptable before it is necessary to activate the backup UE context(s) held by the secondary CU-CP.

Although the above description uses a distributed base station as an example, it will be appreciated that the above techniques for providing resiliency and UE context backup/migration may be applied to other similar communication apparatus that comprises at least a control plane unit and a user plane unit (and appropriate interfaces between the associated units). Such a communication apparatus (at least one unit thereof) may be located in the (radio) access network or the core network.

In the above description, the UE, the (R)AN node (distributed base station), and the core network node are described for ease of understanding as having a number of discrete modules (such as the communication control modules). Whilst these modules may be provided in this way for certain applications, for example where an existing system has been modified to implement the invention, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above embodiments, a number of software modules were described. As those skilled in the art will appreciate, the software modules may be provided in compiled or un-compiled form and may be supplied to the UE, (the units of) the distributed base station, and the core network node as a signal over a computer network, or on a recording medium. Further, the functionality performed by part or all of this software may be performed using one or more dedicated hardware circuits. However, the use of software modules is preferred as it facilitates the updating of the UE, the distributed base station/(R)AN node, and the core network node in order to update their functionalities.

The User Equipment (or “UE”, “mobile station”, “mobile device” or “wireless device”) in the present disclosure is an entity connected to a network via a wireless interface.

It should be noted that the present disclosure is not limited to a dedicated communication device, and can be applied to any device having a communication function (and an associated UE context). The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

For simplicity, the present application often refers to mobile devices in the description but it will be appreciated that the technology described can be implemented on any communication devices (mobile and/or generally stationary) that can connect to a communications network for sending/receiving data, regardless of whether such communication devices are controlled by human input or software instructions stored in memory.

Communication devices might be, for example, mobile communication devices such as mobile telephones, smartphones, user equipment, personal digital assistants, laptop/tablet computers, web browsers, e-book readers and/or the like. Such mobile (or even generally stationary) devices are typically operated by a user. However, 3GPP standards also make it possible to connect so-called ‘Internet of Things’ (IoT) devices (e.g. Narrow-Band IoT (NB-IoT) devices) to the network, which typically comprise automated equipment, such as various measuring equipment, telemetry equipment, monitoring systems, tracking and tracing devices, in-vehicle safety systems, vehicle maintenance systems, road sensors, digital billboards, point of sale (POS) terminals, remote control systems, and the like. Effectively, the Internet of Things is a network of devices (or “things”) equipped with appropriate electronics, software, sensors, network connectivity, and/or the like, which enables these devices to collect and exchange data with each other and with other communication devices. It will be appreciated that IoT devices are sometimes also referred to as Machine-Type Communication (MTC) communication devices or Machine-to-Machine (M2M) communication devices.

The information identifying a further control plane unit may be transmitted as part of at least one of: a procedure for setting up a first interface (e.g. E1) between the control plane unit and the user plane unit; a procedure for setting up a second interface (e.g. F1) between the control plane unit and the distributed unit; a procedure for setting up a third interface (e.g. NG) between the control plane unit and a core network node; a procedure for modifying the first interface; a procedure for modifying the second interface; and a procedure for modifying the third interface. The information identifying the further control plane unit may comprise at least one of an address of the further control plane unit, a name of the further control plane unit, and an identifier of the further control plane unit.

The method performed by the control plane unit may further comprise initiating a procedure for setting up, based on the information identifying the further control plane unit, at least one of: a fourth interface (e.g. redundant E1) between the user plane unit and the further control plane unit to be used in case of a failure of the control plane unit; a fifth interface (e.g. redundant F1) between the distributed unit and the further control plane unit to be used in case of the failure of the control plane unit; and a sixth interface (e.g. redundant NG) between the core network node and the further control plane unit to be used in case of the failure of the control plane unit.

The method performed by the control plane unit may further comprise transmitting, to at least one of the user plane unit and the distributed unit, assistance information for use in determining a failure of the control plane unit. The assistance information may identify or comprise a timer (value).

The method performed by the control plane unit may further comprise backing up at least one UE context associated with the at least one UE served by the control plane unit at the further control plane unit.

A first interface (e.g. E1) may be provided between the control plane unit and the user plane unit, a second interface (e.g. F1) may be provided between the control plane unit and the distributed unit, and a third interface (e.g. NG) may be provided between the control plane unit and a core network node. In this case, the method performed by the communication apparatus may further comprise initiating a procedure for setting up, based on the information identifying the further control plane unit, at least one of: a fourth interface (e.g. redundant E1) between the user plane unit and the further control plane unit to be used in case of a failure of the control plane unit; a fifth interface (e.g. redundant F1) between the distributed unit and the further control plane unit to be used in case of the failure of the control plane unit; and a sixth interface (e.g. redundant NG) between the core network node and the further control plane unit to be used in case of the failure of the control plane unit. In this case, the setting up of the fourth, fifth, or sixth interface may include transmitting at least one message including an indication that the fourth, fifth, or sixth interface is being set up for resiliency.

The method performed by the communication apparatus may further comprise receiving information identifying the control plane unit for use in activating the further control plane unit in a case that the control plane unit fails.

The configuring the further control plane unit may include setting up or modifying the further control plane unit to act as the resilient node.

The at least one signalling message transmitted to the further control plane unit may include information identifying the UE (e.g. UE ID) and the UE context associated with the UE. The at least one signalling message may be transmitted by the control plane unit. The at least one signalling message may be transmitted by the user plane unit. The at least one signalling message may be transmitted by the distributed unit.

The method performed by the communication apparatus may further comprise transmitting, to a core network node, a least one message for establishing a session for the resilient node based on the UE context.

The method performed by the communication apparatus may further comprise: receiving, from the further control plane unit, a least one message including information identifying at least one change to the UE context; and determining, based on the at least one change to the UE context, whether to use the further control plane unit as the resilient node for the control plane unit. In this case, the method may further comprise: transmitting, to the further control plane unit, a message indicating that the at least one change to the UE context is accepted; and using the further control plane unit as the resilient node for the control plane unit based on a modified UE context including the at least one change.

The at least one change to the UE context may include a change to a Packet Data Convergence Protocol (PDCP) configuration associated with the UE context.

The procedure for configuring the further control plane unit to act as the resilient node may include transmitting a request to a core network node for setting up a Protocol Data Unit (PDU) session for the UE via the resilient node.

The method(s) may further comprise initiating a procedure to switch to the further control plane unit as a redundant unit upon failure of the control plane unit (e.g. by transmitting a message for initiating a procedure to activate the resilient node).

The message for initiating a procedure to activate the resilient node may include information identifying the control plane unit of the communication apparatus.

The method performed by the control plane unit configured as the resilient node may further comprise transmitting at least one message to the user plane unit or the distributed unit to indicate that the resilient node has been activated.

The communication apparatus may include a distributed base station apparatus.

Various other modifications will be apparent to those skilled in the art and will not be described in further detail here.

For example, the whole or part of the exemplary embodiments disclosed above can be described as, but not limited to, the following supplementary notes.

### (Supplementary Note 1)

A method performed by a control plane unit of a communication apparatus including at least the control plane unit, a user plane unit, and a distributed unit, the method comprising:
transmitting, to at least one of the user plane unit and the distributed unit, information identifying a further control plane unit to act as a redundant unit for the control plane unit for at least one user equipment (UE) served by the control plane unit.

### (Supplementary Note 2)

The method according to supplementary note 1, wherein the information identifying a further control plane unit is transmitted as part of at least one of:
a procedure for setting up a first interface between the control plane unit and the user plane unit;
a procedure for setting up a second interface between the control plane unit and the distributed unit;
a procedure for setting up a third interface between the control plane unit and a core network node;
a procedure for modifying the first interface;
a procedure for modifying the second interface; and
a procedure for modifying the third interface.

### (Supplementary Note 3)

The method according to supplementary note 1 or 2, wherein the information identifying the further control plane unit comprises at least one of an address of the further control plane unit, a name of the further control plane unit, and an identifier of the further control plane unit.

### (Supplementary Note 4)

The method according to any of supplementary notes 1 to 3, further comprising initiating a procedure for setting up, based on the information identifying the further control plane unit, at least one of:
a fourth interface between the user plane unit and the further control plane unit to be used in case of a failure of the control plane unit;
a fifth interface between the distributed unit and the further control plane unit to be used in case of the failure of the control plane unit; and
a sixth interface between the core network node and the further control plane unit to be used in case of the failure of the control plane unit.

### (Supplementary Note 5)

The method according to any of supplementary notes 1 to 4, further comprising transmitting, to at least one of the user plane unit and the distributed unit, assistance information for use in determining a failure of the control plane unit.

### (Supplementary Note 6)

The method according to supplementary note 5, wherein the assistance information identifies a timer.

### (Supplementary Note 7)

The method according to any of supplementary notes 1 to 6, further comprising backing up at least one UE context associated with the at least one UE served by the control plane unit at the further control plane unit.

### (Supplementary Note 8)

A method performed by a communication apparatus including a control plane unit, a user plane unit, and a distributed unit, the method comprising:
receiving, from at least one of the control plane unit and an operations and maintenance node, information identifying a further control plane unit to act as a redundant unit for the control plane unit for at least one user equipment (UE) served by the control plane unit.

### (Supplementary Note 9)

The method according to supplementary note 8, wherein a first interface is provided between the control plane unit and the user plane unit, a second interface is provided between the control plane unit and the distributed unit, and a third interface is provided between the control plane unit and a core network node, and the method further comprises initiating a procedure for setting up, based on the information identifying the further control plane unit, at least one of:
a fourth interface between the user plane unit and the further control plane unit to be used in case of a failure of the control plane unit;
a fifth interface between the distributed unit and the further control plane unit to be used in case of the failure of the control plane unit; and
a sixth interface between the core network node and the further control plane unit to be used in case of the failure of the control plane unit.

### (Supplementary Note 10)

The method according to supplementary note 9, wherein the setting up of the fourth, fifth, or sixth interface includes transmitting at least one message including an indication that the fourth, fifth, or sixth interface is being set up for resiliency.

### (Supplementary Note 11)

The method according to supplementary note 9 or 10, further comprising receiving information identifying the control plane unit for use in activating the further control plane unit in a case that the control plane unit fails.

### (Supplementary Note 12)

A method performed by a communication apparatus including at least a control plane unit, a user plane unit, and a distributed unit, the method comprising:
initiating a procedure for configuring a further control plane unit to act as a resilient node for the control plane unit by transmitting at least one signalling message to the further control plane unit; and
backing up a UE context associated with a user equipment (UE) served by the control plane unit at the resilient node.

### (Supplementary Note 13)

The method according to supplementary note 12, wherein the configuring the further control plane unit includes setting up or modifying the further control plane unit to act as the resilient node.

### (Supplementary Note 14)

The method according to supplementary note 12 or 13, wherein the at least one signalling message includes information identifying the UE and the UE context associated with the UE.

### (Supplementary Note 15)

The method according to any of supplementary notes 12 to 14, wherein the at least one signalling message is transmitted by the control plane unit.

### (Supplementary Note 16)

The method according to any of supplementary notes 12 to 14, wherein the at least one signalling message is transmitted by the user plane unit.

### (Supplementary Note 17)

The method according to any of supplementary notes 12 to 14, wherein the at least one signalling message is transmitted by the distributed unit.

### (Supplementary Note 18)

The method according to any of supplementary notes 12 to 17, further comprising transmitting, to a core network node, a least one message for establishing a session for the resilient node based on the UE context.

### (Supplementary Note 19)

The method according to any of supplementary notes 12 to 18, further comprising:
receiving, from the further control plane unit, a least one message including information identifying at least one change to the UE context; and
determining, based on the at least one change to the UE context, whether to use the further control plane unit as the resilient node for the control plane unit.

### (Supplementary Note 20)

The method according to supplementary note 19, further comprising: transmitting, to the further control plane unit, a message indicating that the at least one change to the UE context is accepted; and
using the further control plane unit as the resilient node for the control plane unit based on a modified UE context including the at least one change.

### (Supplementary Note 21)

The method according to supplementary note 19 or 20, wherein the at least one change to the UE context includes a change to a Packet Data Convergence Protocol (PDCP) configuration associated with the UE context.

### (Supplementary Note 22)

The method according to any of supplementary notes 1 to 20, wherein the procedure for configuring the further control plane unit to act as the resilient node includes transmitting a request to a core network node for setting up a Protocol Data Unit (PDU) session for the UE via the resilient node.

### (Supplementary Note 23)

The method according to any of supplementary notes 1 to 22, further comprising initiating a procedure to switch to the further control plane unit as a redundant unit upon failure of the control plane unit.

### (Supplementary Note 24)

A method performed by a communication apparatus including at least a control plane unit configured as a control plane unit, a user plane unit, and a distributed unit, coupled to a further control plane unit configured as a resilient node for the control plane unit, the method comprising: determining a failure of the control plane unit; and
transmitting a message to the further control plane unit for initiating a procedure to activate the further control plane unit as the resilient node.

### (Supplementary Note 25)

A method performed by a control plane unit configured as a resilient node for a control plane unit of a communication apparatus comprising a user plane unit and a distributed unit, the method comprising:
receiving, from the user plane unit or the distributed unit, a message for initiating a procedure to activate the resilient node, in case of a failure of the control plane unit of the communication apparatus; and
communicating with at least one user equipment (UE), using the user plane unit or the distributed unit.

### (Supplementary Note 26)

The method according to supplementary note 24 or 25, wherein the message includes information identifying the control plane unit of the communication apparatus.

### (Supplementary Note 27)

The method according to any of supplementary notes 24 to 26, further comprising transmitting at least one message to the user plane unit or the distributed unit to indicate that the resilient node has been activated.

### (Supplementary Note 28)

The method according to any of supplementary notes 1 to 27, wherein the communication apparatus includes a distributed base station apparatus.

### (Supplementary Note 29)

A method performed by an operations and maintenance node, the method comprising:
transmitting, to a node of a communication apparatus including a control plane unit, a user plane unit, and a distributed unit, information identifying a further control plane unit to act as a redundant unit for the control plane unit for at least one user equipment (UE) served by the control plane unit.

### (Supplementary Note 30)

A control plane unit for a communication apparatus including at least the control plane unit, a user plane unit, and a distributed unit, the control plane unit comprising:
means for transmitting, to at least one of the user plane unit and the distributed unit, information identifying a further control plane unit to act as a redundant unit for the control plane unit for at least one user equipment (UE) served by the control plane unit.

### (Supplementary Note 31)

A communication apparatus including a control plane unit, a user plane unit, and a distributed unit, the communication apparatus comprising:
means for receiving, from at least one of the control plane unit and an operations and maintenance node, information identifying a further control plane unit to act as a redundant unit for the control plane unit for at least one user equipment (UE) served by the control plane unit.

### (Supplementary Note 32)

A communication apparatus including at least a control plane unit, a user plane unit, and a distributed unit, the communication apparatus comprising:
means for initiating a procedure for configuring a further control plane unit to act as a resilient node for the control plane unit by transmitting at least one signalling message to the further control plane unit; and
means for backing up a UE context associated with a user equipment (UE) served by the control plane unit at the resilient node.

### (Supplementary Note 33)

A communication apparatus including at least a control plane unit configured as a control plane unit, a user plane unit, and a distributed unit, coupled to a further control plane unit configured as a resilient node for the control plane unit, the communication apparatus comprising:
means for determining a failure of the control plane unit; and means for transmitting a message to the further control plane unit for initiating a procedure to activate the further control plane unit as the resilient node.

### (Supplementary Note 34)

A control plane unit for being configured as a resilient node for a control plane unit of a communication apparatus including a user plane unit and a distributed unit, the control plane unit comprising:
means for receiving, from the user plane unit or the distributed unit, a message for initiating a procedure to activate the resilient node, in case of a failure of the control plane unit of the communication apparatus; and
means for communicating with at least one user equipment (UE), using the user plane unit or the distributed unit.

### (Supplementary Note 35)

An operations and maintenance node comprising:
means for transmitting, to a node of a communication apparatus including a control plane unit, a user plane unit, and a distributed unit, information identifying a further control plane unit to act as a redundant unit for the control plane unit for at least one user equipment (UE) served by the control plane unit.

This application is based upon and claims the benefit of priority from Great Britain Patent Application No. 2202786.6, filed on Mar. 1, 2022, the disclosure of which is incorporated herein in its entirety by reference.

### REFERENCE SIGNS LIST

1 TELECOMMUNICATION SYSTEM
3 MOBILE DEVICE
5 BASE STATION
7 CORE NETWORK
8 ACCESS AND MOBILITY MANAGEMENT FUNCTION
9 SESSION MANAGEMENT FUNCTION
10 EXTERNAL IP NETWORK
31 TRANSCEIVER CIRCUIT
33 ANTENNA
35 USER INTERFACE
37 CONTROLLER
39 MEMORY
41 OPERATING SYSTEM
43 COMMUNICATIONS CONTROL MODULE
51 TRANSCEIVER CIRCUIT
53 ANTENNA
55 NETWORK INTERFACE
57 CONTROLLER
59 MEMORY
61 OPERATING SYSTEM
63 COMMUNICATIONS CONTROL MODULE
5C gNB-CU-CP MODULE
5U gNB-CU-UP MODULE
5D gNB-DU MOULE
71 TRANSCEIVER CIRCUIT
75 NETWORK INTERFACE
77 CONTROLLER
79 MEMORY
81 OPERATING SYSTEM
83 COMMUNICATIONS CONTROL MODULE

What is claimed is:

1. A method performed by a network node, the method comprising:
transmitting, to at least one of a user plane unit of a distributed base station and a distributed unit of the distributed base station, information identifying a further control plane unit to act as a redundant unit for a control plane unit of the distributed base station for a user equipment (UE) served by the control plane unit, before any connections for UEs are not established at the network node, wherein
the information is used for activating the further control plane unit to act as the redundant unit due to a failure of the control plane unit.

2. The method according to claim 1, wherein the network node is the control plane unit, or an Operation and Maintenance (OAM) node.

3. (canceled)

4. The method according to claim 2, wherein
the network node is the control plane unit, and
the method further comprises:
transmitting, to the further control plane unit, a UE context associated with the UE for backup at the further control plane unit.

5. The method according to claim 4, wherein
the UE context includes Protocol Data Convergence Protocol (PDCP) configuration, and the method comprises:
receiving, from the further control plane unit, a reject message indicating that the further control plane unit does not accept the UE context with the PDCP configuration, and including a supported UE context with PDCP configuration; and
determining whether the supported UE context with PDCP configuration is accepted.

6. The method according to claim 4, wherein
the transmitting the UE context is performed in a case where the UE context is setup/modified/released at the network node.

7. The method according to claim 1, wherein the information is transmitted as part of at least one of:
a procedure for setting up a first interface between the control plane unit and the user plane unit;
a procedure for setting up a second interface between the control plane unit and the distributed unit;
a procedure for setting up a third interface between the control plane unit and a core network node;
a procedure for modifying the first interface;
a procedure for modifying the second interface; and
a procedure for modifying the third interface.

8. (canceled)

9. The method according to claim 1, further comprising:
transmitting, to the at least one of the user plane unit and the distributed unit, assistance information for determining a failure of the control plane unit.

10. (canceled)

11. A method performed by a network unit in a distributed base station including a control plane unit, a user plane unit and distributed unit, coupled to a further control plane unit configured as a resilient node for the control plane unit, the method comprising:
determining a failure of the control plane unit; and
transmitting, to the further control plane unit, a message for initiating a procedure to activate the further control plane unit to act as the resilient node, wherein
the further control plane unit is configured as the resilient node before any connections for user equipments (UEs) are not established at the distributed base station.

12. The method according to claim 11, further comprising:
receiving, from at least one of the control plane unit and an operation and maintenance (OAM) node, information identifying the further control plane unit.

13. The method according to claim 12, further comprising:
initiating a procedure for setting up, based on the information identifying the further control plane unit, an interface between the network unit and the further control plane unit, to be used in case of the failure of the control plane unit.

14. The method according to claim 13, wherein
the initiating the procedure for setting up the interface causes the further control plane unit to setting up an interface between the further control plane unit and a core network node to be used in case of the failure of the control plane unit.

15-17. (canceled)

18. A method performed by a further control plane unit, the method comprising:
receiving, from a network unit in a distributed base station including a control plane unit and the network unit, a message for initiating a procedure to activate to act as a resilient node for the control plane unit, in case of a failure of the control plane unit, and
communicating with a user equipment (UE), using the network unit, wherein
the further control plane unit is configured as the resilient node before any connections for UEs are not established at the distributed base station.

19. The method according to claim 18, further comprising:
initiating a procedure for setting up, based on information identifying the further control plane unit transmitted to the network unit, an interface between the network unit and the further control plane unit, to be used in case of the failure of the control plane unit.

20. The method according to claim 19, further comprising:
initiating a procedure for setting up, based on the initiating the procedure for setting up the interface between the network unit and the further control plane unit, an interface between the further control plane unit and a core network node, to be used in case of the failure of the control plane unit.

21. The method according to claim 18, further comprising:
receiving a UE context associated with the UE for backup at the further control plane unit.

22. The method according to claim 21, wherein
the UE context includes Protocol Data Convergence Protocol (PDCP) configuration, and the method comprises:
determining whether the UE context with the PDCP configuration is accepted, and
transmitting a reject message indicating that the further control plane unit does not accept the UE context with the PDCP configuration, and including a supported UE context with PDCP configuration.

23. The method according to claim 21, further comprising:
transmitting, to a core network node, a message for establishing a Protocol Data Unit (PDU) session for the resilient node based on the UE context.

24. (canceled)

25. A network node comprising:
means for transmitting, to at least one of a user plane unit of a distributed base station and a distributed unit of the distributed base station, information identifying a further control plane unit to act as a redundant unit for a control plane unit of the distributed base station for a user equipment (UE) served by the control plane unit, before any connections for UEs are not established at the network node, wherein
the information is used for activating the further control plane unit to act as the redundant unit due to a failure of the control plane unit.

26. A network unit in a distributed base station including a control plane unit, a user plane unit, and a distributed unit, coupled to a further control plane unit configured as a resilient node for the control plane unit, the network unit comprising:
means for determining a failure of the control plane unit; and
means for transmitting, to the further control plane unit a message for initiating a procedure to activate the further control plane unit to act as the resilient node, wherein
the further control plane unit is configured as the resilient node before any connections for user equipments (UEs) are not established at the distributed base station.

27. A further control plane unit, the further control plane unit comprising:
means for receiving, from a network unit in a distributed base station including a control plane unit and the network unit, a message for initiating a procedure to activate to act as a resilient node for the control plane unit, in case of a failure of the control plane unit; and
means for communicating with a user equipment (UE), using the network unit, wherein
the further control plane unit is configured as the resilient node before any connections for UEs are not established at the distributed base station.
